(19) United States
(12) Patent Application Publication
(10) Pub. No.: US 2026/0340087 A1
(43) Pub. Date: Oct. 29, 2026

(54) SERVER DEVICE, TRADING SYSTEM, TRADING METHOD, AND PROGRAM

(71) Applicant: Sharp Kabushiki Kaisha, Sakai City (JP)

(72) Inventor: Shinya UEDA, Sakai City (JP)

(21) Appl. No.: 19/699,532

(22) Filed: Jun. 5, 2026

Related U.S. Application Data
(63) Continuation of application No. PCT/JP2024/007554, filed on Feb. 29, 2024.

(51) Int. Cl. G06F 21/10

(52) U.S. Cl. CPC G06F 21/108

(57) ABSTRACT

A generator generates first information free of color information of content as trading target and second information corresponding to the color information, based on the content. A first respondent transmits the first information and a request for registration of a viewing terminal device for viewing the content to a terminal device of a purchaser who purchased a content and stores, in a storage, identification information of the viewing terminal device provided by a notification in response to the registration request. A second respondent determines whether or not identification information of a terminal device included in a transmission request for transmission of the second information matches the identification information of the viewing terminal device stored in the storage in case that the transmission request has been received and transmits the second information to the viewing terminal device in case that it is determined that the identification information matches.

### BACKGROUND OF THE INVENTION

### Field of the Invention

The present invention relates to a server device, a trading system, a trading method, and a program.

### Description of Related Art

There is non-fungible token (NFT) art (e.g., Patent Document 1). The NFT art is digital content whose uniqueness and holder can be verified by embedding individual information (token) using a blockchain. In a marketplace (NFT marketplace) that handles NFT art, trading for purchasing and selling NFT art can be performed.

### Patent Documents

[Patent Document 1] Japanese Patent No. 7058898

### SUMMARY

However, although the use of a blockchain can suppress the falsification of trading in an NFT marketplace, it is difficult to suppress the copying of NFT art by third parties. The technology described in Patent Document 1 does not disclose how to suppress the copying of NFT art data. For example, it is possible for third parties to copy original NFT art and offer the copied NFT art. For this reason, there is a need for a system that makes the copying of NFT art difficult.

In view of the above-described problems, an objective of the present invention is to make a copy of NFT art difficult.

According to an aspect of the present invention, there is provided a server device including: a generator configured to generate first information that is free of color information of content that is trading target content and second information corresponding to the color information, based on the content; a first respondent configured to transmit the first information and a registration request for requesting registration of a viewing terminal device for viewing the content to a terminal device of a purchaser who has performed a content purchase procedure and store identification information of the viewing terminal device provided by a notification in response to the registration request in a storage; and a second respondent configured to determine whether or not identification information of a terminal device included in a transmission request for requesting transmission of the second information matches the identification information of the viewing terminal device stored in the storage in case that the transmission request has been received and transmit the second information to the viewing terminal device in case that it is determined that the identification information matches.

Moreover, according to an aspect of the present invention, there is provided a trading system including: the above-described server device; and the viewing device.

Moreover, according to an aspect of the present invention, there is provided a trading method, which is performed by a server device that is a computer, the trading method including: generating, by an acquisition unit, first information that is free of color information of content that is trading target content and second information corresponding to the color information, based on the content; transmitting, by a first respondent, the first information and a registration request for requesting registration of a viewing terminal device for viewing the content to a terminal device of a purchaser who has performed a content purchase procedure and storing identification information of the viewing terminal device provided by a notification in response to the registration request in a storage; and determining, by a second respondent, whether or not identification information of a terminal device included in a transmission request for requesting transmission of the second information matches the identification information of the viewing terminal device stored in the storage in case that the transmission request has been received and transmitting the second information to the viewing terminal device in case that it is determined that the identification information matches.

Moreover, according to an aspect of the present invention, there is provided a program for causing a server device that is a computer to: generate first information that is free of color information of content that is trading target content and second information corresponding to the color information, based on the content; transmit the first information and a registration request for requesting registration of a viewing terminal device for viewing the content to a terminal device of a purchaser who has performed a content purchase procedure and store identification information of the viewing terminal device provided by a notification in response to the registration request in a storage; and determine whether or not identification information of a terminal device included in a transmission request for requesting transmission of the second information matches the identification information of the viewing terminal device stored in the storage in case that the transmission request has been received and transmit the second information to the viewing terminal device in case that it is determined that the identification information matches.

According to the present invention, it is possible to make a copy of NFT art difficult.

### BRIEF DESCRIPTION OF THE DRAWINGS

FIG. 1 is a block diagram showing a configuration of a trading system in an embodiment.

FIG. 2 is a block diagram showing a configuration of a server device in an embodiment.

FIG. 3 is a diagram showing an example of circulation management information in an embodiment.

FIG. 4 is an explanatory sequence diagram of a flow of a process performed by the trading system in an embodiment.

FIG. 5 is an explanatory sequence diagram of a flow of a process performed by the trading system in an embodiment.

FIG. 6 is an explanatory diagram of a basic configuration of the trading system in an embodiment.

FIG. 7 is an explanatory sequence diagram of a flow of a process performed by a conventional trading system.

### DETAILED DESCRIPTION OF THE INVENTION

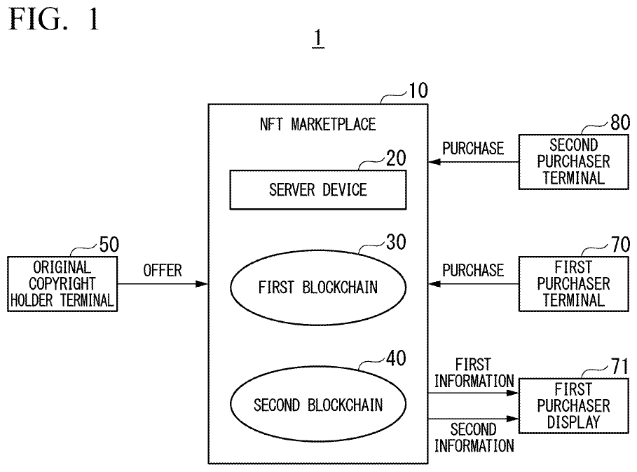

Embodiments of the present invention will be described below. FIG. 1 is an explanatory block diagram of a configuration of a trading system in an embodiment. A trading system 1 includes an NFT marketplace 10 and a plurality of user terminals.

The plurality of user terminals are terminal devices that are operated by a plurality of users who use the NFT marketplace 10, and may be, for example, smartphones, personal computers (PCs), tablet terminals, or the like.

In FIG. 1, an original copyright holder terminal 50, a first purchaser terminal 70, a first purchaser display 71, and a second purchaser terminal 80 are shown as the plurality of user terminals. The first purchaser terminal 70 is a terminal device that is operated by Purchaser 1 who is a purchaser of NFT art. The first purchaser display 71 is a display terminal that displays the NFT art purchased by Purchaser 1. The first purchaser terminal 70 and the first purchaser display 71 may be the same device or different devices. The second purchaser terminal 80 is a terminal device operated by a purchaser (Purchaser 2) different from Purchaser 1.

In the trading system 1, the NFT marketplace 10 and each of the user terminals are communicatively connected. It is only necessary for a communication means for the NFT marketplace 10 and each user terminal of a user terminal group to be any means that at least enables communication, such as the Internet, a wired LAN, a wireless LAN, or a combination thereof, and is not limited to any specific means.

The NFT marketplace 10 is a marketplace for dealing with NFT art. The NFT art is digital content associated with an NFT. The digital content here includes still and moving images including objects of two-or three-dimensional shapes, such as digital paintings, illustrations, animations, trading cards, and game items.

The NFT marketplace 10 uses the blockchain to manage attribute information of digital content associated with a non-fungible token (NFT), for example, a holder. By using the blockchain to manage the attribute information of the digital content associated with the NFT, it is possible to prove the uniqueness and holder of the digital content associated with the NFT. Users can purchase and sell the NFT art using the NFT marketplace 10.

The NFT marketplace 10 has functions related to NFT art trading, such as issuing, purchasing, and selling NFTs. For example, the NFT marketplace 10 issues NFTs in response to an NFT issuance request, trades NFTs in response to a request for trading the NFTs, settles NFT payments, and the like.

FIG. 7 is an explanatory sequence diagram of a flow of a process performed by a conventional trading system. The original copyright holder terminal 50 performs an offer procedure by requesting the server device 200, which handles trading in conventional NFT marketplaces, to issue an NFT corresponding to digital content created by an original author (step S1). The server device 200, for example, executes information processing according to the NFT issuance request from the original author of the digital content (step 2). As the information processing according to the NFT issuance request, the server device 200 issues the NFT associated with the digital content for which the original author has requested the issuance of the NFT, and records information about the original author who has requested the issuance of the NFT on the blockchain as information about the holder of the issued NFT.

If the NFT is issued and attribute information about its holder and the like are recorded on the blockchain, users can browse the digital content corresponding to the NFT in the NFT marketplace. In this way, the digital content is circulated in the market as a trading target. If information processing according to the NFT issuance request is executed, the server device 200 transmits a registration completion notification indicating that offer registration has been completed to the original copyright holder terminal 50 (step S3).

On the other hand, the first purchaser terminal 70 performs a purchase procedure by transmitting a purchase request for the NFT associated with the NFT art to the server device 200 (step S4). The server device 200 executes information processing according to an NFT purchase request from Purchaser 1 (step S5). As the information processing according to the NFT purchase request, the server device 200 sells the NFT associated with the digital content created by the original author to Purchaser 1 and records information about Purchaser 1 who has requested the NFT purchase on the blockchain as information about a holder of the sold NFT. If information processing according to the NFT purchase request is executed, the server device 200 transmits the digital content corresponding to the purchased NFT to the first purchaser terminal 70 (step S6).

Here, a trading history is recorded on the blockchain in the NFT marketplace, but it is not checked whether or not the digital art offered using the blockchain is an original or a copy. Therefore, the copied NFT art (copied art) can be offered on the NFT marketplace, potentially leading to the circulation of such art (step S700).

A flow of a process performed in step S700 will be specifically described. The first purchaser terminal 70 performs a procedure for offering the copied art, which is a copy of the purchased digital content (step S7). If Purchaser 1 has correctly performed the NFT issuance request procedure in step S7, the server device 200 issues an NFT associated with the copied art and records information about Purchaser 1 as the holder of the issued NFT on the blockchain. Thereby, the copied art that looks identical to the original but has a different built-in NFT may be offered to the NFT marketplace. If information processing according to the NFT issuance request is executed, the server device 200 transmits a registration completion notification to the first purchaser terminal 70 (step S8).

The second purchaser terminal 80 performs the purchase procedure by transmitting an NFT purchase request associated with the copied art to the server device 200 (step S9). If Purchaser 2 correctly performs an NFT purchase request procedure, the server device 200 executes information processing according to the NFT purchase request and transmits digital content (copied art) corresponding to the purchased NFT to the second purchaser terminal 80 (step S10).

In this way, Purchaser 2 is likely to purchase copied art without recognizing that it is a copy. If it is proved that the digital art purchased by Purchaser 2 as an original is in fact a copy, the reliability of trading in the NFT marketplace may be reduced. Because different NFTs are associated with the original and the copy, it is considered that copied art is detected based on the similarity of the digital content's appearance, an NFT difference, a trading history, and the like. However, there are limitations in detecting copied art in real time in an NFT marketplace where a large amount of NFT art is circulating.

To address this issue, the NFT marketplace of the present embodiment makes it difficult to copy NFT art. Specifically, the content information for digital content offered to the NFT marketplace 10 is divided into two pieces of information, such that the two pieces of information are managed separately and only the purchaser can reproduce the digital content using the two pieces of information. For example, in case that the digital content is a still image or a moving image, the digital content can be reproduced by displaying the digital content on a display. The NFT marketplace 10 of the present embodiment will be described below.

As shown in FIG. 1, the NFT marketplace 10 includes a server device 20 and two blockchains (a first blockchain 30 and a second blockchain 40).

The server device 20 is a computer that executes NFT art trading. For example, a certain server device, a cloud, a PC, or the like can be used as the server device 20. The server device 20 uses two blockchains (the first blockchain 30 and the second blockchain 40) to manage content information for digital content offered to the NFT marketplace 10.

Specifically, the server device 20 generates the two pieces of information (first information and second information) from the content information. The first information is information obtained by excluding the second information from the content information. The second information is partial information of the content information. The content information can be generated by combining the first information and the second information.

The server device 20 manages the content information in the first blockchain 30. Specifically, the server device 20 issues an NFT associated with the content information and records information about the original author who has requested the issuance of the NFT on the first blockchain 30 as information that is attribute information (e.g., a holder) of the issued NFT.

On the other hand, the server device 20 manages the second information using a means separate from the first blockchain 30. As a means separate from the first blockchain 30, a means for performing management using a blockchain different from the first blockchain 30, a means for storing data in a secure database, or the like is conceivable. In the present embodiment, an example in which the second information is managed using the second blockchain 40 (a blockchain different from the first blockchain 30) will be described. The server device 20 issues an NFT associated with the second information and records information about the original author who has requested the issuance of the NFT on the blockchain as the information about the holder of the issued NFT.

Here, in addition to information about the NFT holder, the second blockchain 40 records the identification information of the viewing device as attribute information of the second information on the blockchain. The viewing device will be described below.

The server device 20 enables a user to browse content information in the NFT marketplace and receives an NFT purchase request associated with the content information. In case that the content information is circulated in the NFT marketplace, the user can browse digital content offered to the market and consider purchasing the digital content.

In case that the digital content includes content including a color, information corresponding to the content's color information can be used as the second information. In this case, the second information is a lookup table associated with information indicating a color tone of each pixel as a pixel value (e.g., RGB values). The second information may be identification information (e.g., a color tone ID, a color ID, or the like) for uniquely identifying the lookup table, in addition to or instead of the above-described lookup table. Moreover, the color information may include all of hue, saturation, and brightness, or some of the color information may not be included.

The first information is information that does not include color information of the content. For example, the first information is information obtained by excluding authentic color information (second color information) from the content information. Alternatively, the first information may be information to which dummy color information indicating an unauthentic dummy color has been added in place of the color information excluded from the content information. The dummy color information is, for example, binarized information in which the authentic color information has been converted into two values (e.g., white and black).

The first information is information obtained by excluding at least partial information from the content information, and it is only necessary for the first information to be information for which the digital content cannot be completely reproduced due to the exclusion of the partial information.

In case that dummy information is added to the first information, it may include information indicating that the dummy information is not authentic information (second information).

Moreover, the first information may include information (incomplete information) indicating that it is authentic content from which partial information (second information) has been excluded.

An example in which the digital content is content including a color and the second information is authentic color information in the content information will be described below.

As information processing according to a purchase request for an NFT associated with the content information, the server device 20 records information about the NFT purchaser (the next NFT holder) on the first blockchain 30. Examples of information about the NFT purchaser (the next NFT holder) are a purchaser ID, a purchase number, and the like.

Here, as information processing according to a purchase request for an NFT associated with the content information, the server device 20 of the present embodiment further transmits a registration request to the terminal (e.g., the first purchaser terminal 70) that has provided a notification of the purchase request for the NFT associated with the content information.

The registration request is a notification for requesting registration of a viewing device. The viewing device is a device on which the purchaser who has purchased the NFT views the digital content corresponding to the purchased NFT and is the first purchaser display 71 in the example of the drawing. The first purchaser terminal 70 and the first purchaser display 71 may be the same device or different devices. The server device 20 records the device identification information of the viewing device registered by the purchaser (e.g., the first purchaser display 71) on the second blockchain 40 in association with the second information of the digital content purchased by the purchaser.

The server device 20 transmits the first information and the second information corresponding to the purchased NFT to the viewing device registered by the purchaser (e.g., the first purchaser display 71). Here, after the first information is transmitted, the server device 20 transmits the second information in accordance with a request from the viewing device. The server device 20 performs device authentication for determining whether or not the device requesting the transmission of the second information is a device registered as the viewing device. Only if it is determined that the device requesting the second information is the viewing device according to device authentication, the server device 20 transmits the second information to that device (viewing device). Details of a specific process for performing a device authentication process in the server device 20 will be described in detail below.

In this way, in the trading system 1 of the present embodiment, the first information is transmitted to a purchaser having purchased an NFT associated with content information, the viewing device is registered, and the second information is transmitted to only the registered viewing device. Thereby, it is possible to reproduce authentic digital content using the second information (e.g., authentic color information) only on the viewing device. Because the purchaser is notified of the first information obtained by excluding a part of the content information, any attempt to copy the content will result in a copy of the first information. Thus, it is difficult to copy NFT art. Therefore, in the trading system 1 of the present embodiment, it is possible to make the copying of NFT art difficult.

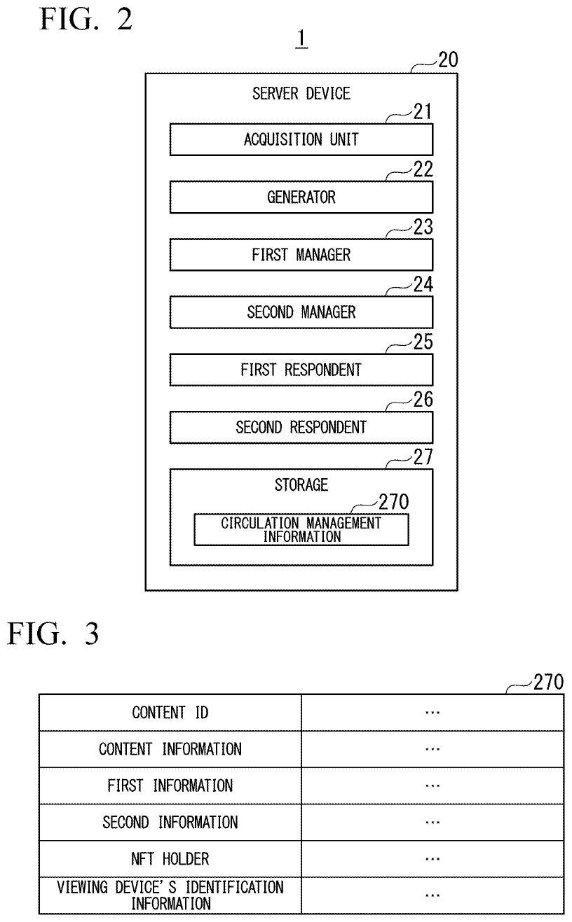

FIG. 2 is a block diagram showing a configuration of a server device in the present embodiment. As shown in FIG. 2, the server device 20 includes an acquisition unit 21, a generator 22, a first manager 23, a second manager 24, a first respondent 25, a second respondent 26, and a storage 27.

The acquisition unit 21 acquires various types of information. For example, in case that an NFT issuance request is transmitted from a terminal device (e.g., the original copyright holder terminal 50) of a user who desires to offer digital content to the NFT marketplace 10, the NFT marketplace 10 issues an NFT in accordance with the NFT issuance request. If the NFT is issued in the NFT marketplace 10, the acquisition unit 21 acquires content information for the digital content corresponding to the issued NFT. A notification of this content information is provided to the NFT marketplace 10, for example, from the terminal device (e.g., the original copyright holder terminal 50) of the user who has transmitted the NFT issuance request, along with the NFT issuance request. The acquisition unit 21 outputs the acquired content information to the generator 22. The acquisition unit 21 stores the acquired content information as circulation management information 270 in the storage 27.

The generator 22 generates the first information and the second information from the content information. The generator 22 generates the first information by excluding color information (the second information) indicating the color of the digital content from the content information. The generator 22 may be configured to generate the first information including incomplete information.

The generator 22 generates color information indicating an authentic color of the digital content as the second information. The generator 22 stores the generated first and second information as the circulation management information 270 in the storage 27.

The first manager 23 circulates a non-fungible token (NFT) associated with the content information in the NFT marketplace 10. The NFT marketplace 10 is a market where a holder of the non-fungible token (NFT) is managed using a blockchain. The first manager 23 issues the NFT associated with the content information and records information about the original author who has requested the issuance of the NFT on the first blockchain 30 as information about the holder of the issued NFT. Thereby, the first manager 23 offers digital content by circulating the non-fungible token (NFT) associated with the content information in the NFT marketplace 10 as a trading target in the NFT marketplace 10.

Here, the first manager 23 may be configured to offer content consisting only of the first information to the NFT marketplace 10. In this case, the first manager 23 designates the non-fungible token associated with the first information as a trading target in the NFT marketplace 10 and circulates digital content corresponding to the first information in the NFT marketplace 10, i.e., a market in which the holder of the non-fungible token is managed using a blockchain.

The second manager 24 manages the second information in association with the first information. The second manager 24 manages the second information, for example, by managing the non-fungible token (NFT) associated with the second information using the blockchain. The second manager 24 issues the NFT associated with the second information and records information about the original author who has requested the issuance of the NFT in the second blockchain 40 as information about the holder of the issued NFT. Thereby, the second manager 24 manages the second information. Alternatively, the second manager 24 may be configured to manage the second information by storing information (the circulation management information 270) in which the first information and the second information are associated in the storage 27.

The first respondent 25 performs a process corresponding to the trading (purchase) of NFT art (digital content) offered to the NFT marketplace 10.

In case that Purchaser 1 purchases a non-fungible token (NFT) associated with content information, a notification of an NFT purchase request is provided to the NFT marketplace 10 from the first purchaser terminal 70. The first respondent 25 acquires the NFT purchase request of which the NFT marketplace 10 is notified via the acquisition unit 21 of the server device 20. As information processing according to the NFT purchase request, the first respondent 25 sells the NFT associated with the content information to Purchaser 1 and records information about Purchaser 1 who has made the NFT purchase request on the first blockchain 30 as information about the holder of the sold NFT. Thereby, the holder of the NFT becomes Purchaser 1, and the trading of the digital content is valid in the NFT marketplace 10.

If the trading of the digital content is valid, the first respondent 25 transmits a registration request to the first purchaser terminal 70, which is the terminal device of Purchaser 1. The registration request is a notification for requesting registration of the device (the viewing device) on which Purchaser 1 will view the digital content that has been purchased. This registration request becomes, for example, a request for providing the notification of the identification information of the viewing device. As examples of the viewing device's identification information, a model name of the viewing device, a serial number unique to the viewing device, and the like can be used. This viewing device's identification information is used as signature information for use in verifying whether or not to comply with the second information request notification to be described below.

In response to the registration request, the first purchaser terminal 70, for example, provides a notification of a serial number of the first purchaser display 71 as the viewing device's identification information. The first respondent 25 stores the viewing device's identification information indicated in the notification provided in response to the registration request as information associated with the content (the circulation management information 270) in the storage 27. The first respondent 25 records the device identification information of the viewing device as attribute information of the second information on the second blockchain 40 in association with the NFT corresponding to the second information.

The second respondent 26 transmits the second information corresponding to the digital content purchased by the purchaser to the viewing device based on the identification information of the viewing device stored in the storage 27.

For example, in the trading system 1, a program (hereinafter referred to as a display program) for displaying digital content using the first information and the second information is provided in advance for users using the NFT marketplace 10.

Here, the server device 20 transmits the first information to the first purchaser terminal 70 along with a guide message such as “Copy the first information to the viewing device and display the digital content on the viewing device.” Alternatively, the server device 20 may directly transmit the first information to the viewing device.

Moreover, the server device 20 transmits the display program to the terminal device of the user who has registered the viewing device (e.g., the first purchaser terminal 70) along with a guide message such as “It is possible to display the digital content by installing the display program on the viewing device.”

The purchaser installs the display program on their viewing device in accordance with the guide message and stores an electronic file corresponding to the first information in the viewing device.

In case that the purchaser performs an operation for operating the viewing device to activate the display program and display the digital content, a function of acquiring the second information via the display program is executed in the viewing device. Specifically, the viewing device notifies the server device 20 of its own (viewing device) device identification information and transmits a request notification for requesting the second information to the server device 20. Here, a third-party device disguised as the viewing device may notify the server device 20 of its own (third-party device) device identification information and transmit a request notification for requesting the second information to the server device 20.

The second respondent 26 acquires request notifications from devices (including the viewing device and the third-party device) via the acquisition unit 21 of the server device 20. In case that the request notification is acquired, the second respondent 26 determines whether or not the device (terminal device) having provided the request notification is a viewing device registered by the purchaser, based on the device identification information included in the request notification.

For example, in case that the request notification is acquired, the second respondent 26 determines whether or not the device corresponding to the device identification information has been registered as the viewing device with reference to the storage 27 based on the device identification information included in the request notification. In case that the device identification information included in the request notification is stored as the identification information of the viewing device in the circulation management information 270 of the storage 27, the second respondent 26 determines that the device corresponding to the device identification information has been registered as the viewing device. On the other hand, in case that the device identification information included in the request notification is not stored as the identification information of the viewing device in the circulation management information 270 of the storage 27, the second respondent 26 determines that the device corresponding to the device identification information is not registered as the viewing device. In case that it is determined that the device (terminal device) having provided the request notification is a viewing device, the second respondent 26 transmits the second information of the digital content associated with that viewing device to the device (viewing device) that has provided the request notification. Thereby, the second information is transmitted from the server device 20 to the viewing device.

The viewing device receives the second information from the server device 20. If the second information is received, the viewing device displays an authentic digital content using the received second information via a display program. Thereby, the authentic digital content is reproduced only on the viewing device (e.g., the first purchaser display 71) registered by Purchaser 1 who has purchased the NFT.

The storage 27 includes a storage medium, for example, a hard disk drive (HDD), a flash memory, an electrically erasable programmable read-only memory (EEPROM), a random access read/write memory (RAM), a read-only memory (ROM), or any combination of these storage media. The storage 27 stores the circulation management information 270. For example, a non-volatile memory can be used for the circulation management information 270.

FIG. 3 is a diagram showing an example of the circulation management information 270 in the embodiment. The circulation management information 270 is information about digital content that is offered to the NFT marketplace 10 and circulated in the market as a trading target. The circulation management information 270, for example, stores information corresponding to items such as a content ID, content information, first information, second information, an NFT holder, and the viewing device's identification information.

The content ID is identification information for uniquely identifying digital content offered to the NFT marketplace 10.

The content information is information about the digital content offered to the NFT marketplace 10. If the digital content is a still image or a moving image, for example, the content information is an image file representing the still image or the moving image.

The first information is information obtained by excluding partial information (second information) from the content information. The first information is, for example, image information of a binarized image to which binarized information is added, the binarized information being obtained by excluding color information (information indicating RGB values for each pixel) as second information included in the content information and binarizing RGB values into either white or black as dummy color information substituting therefor.

The second information is information excluded from the content information in case that the first information is generated.

The NFT holder is information indicating the holder who holds the NFT associated with the first information. This information indicating the NFT holder is information managed using the blockchain. For example, every time an NFT is traded and the NFT holder changes, information indicating the NFT holder is recorded on the first blockchain 30.

The viewing device's identification information is identification information of a device registered by a purchaser who has purchased an NFT as the viewing device for viewing digital content corresponding to the purchased NFT. The identification information may be any information for identifying the device, and may be, for example, a serial number. The viewing device's identification information is information managed using the blockchain. For example, every time an NFT is traded and the viewing device is registered by the purchaser of the NFT, the viewing device's identification information is recorded on the second blockchain 40.

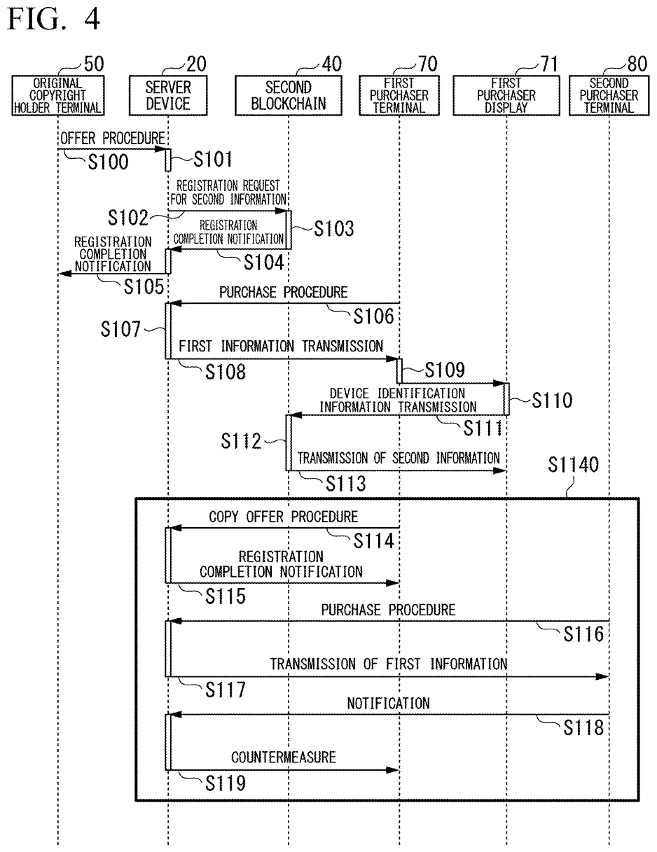

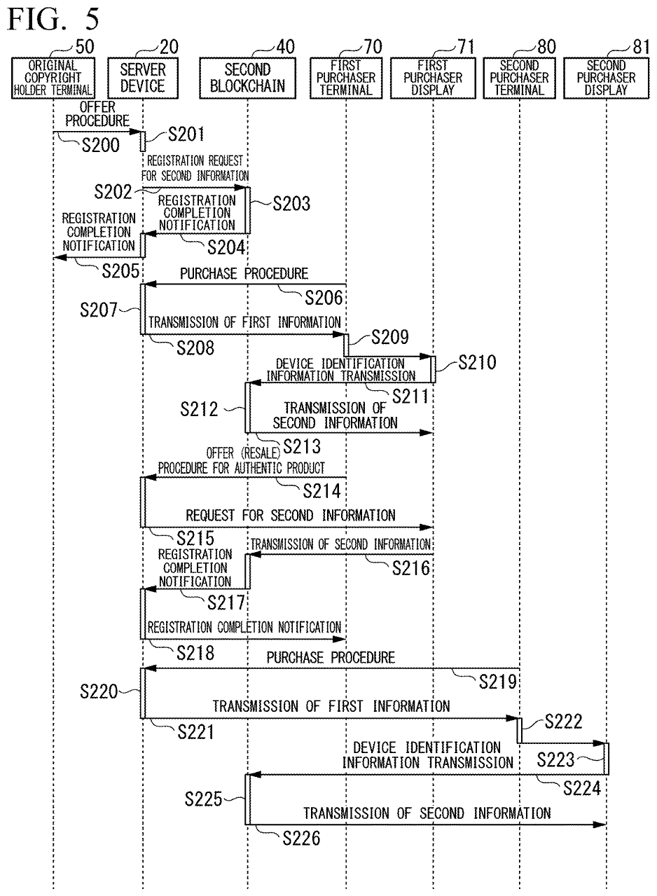

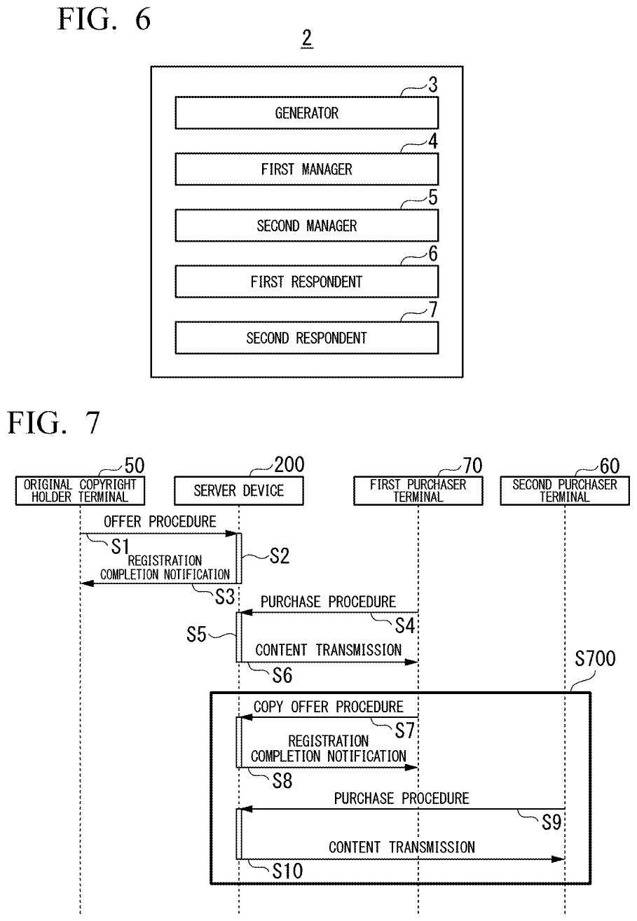

FIGS. 4 and 5 are explanatory sequence diagrams of a flow of a process performed by the trading system 1 of the present embodiment.

In FIG. 4, a flow of a series of processing steps from the time in case that digital art is offered in the NFT marketplace 10 to the time in case that the offered digital art is purchased and the purchased digital art is viewable (steps S100 to S113) is shown. Moreover, in FIG. 4, a flow of a process of a case where copied art is offered to the NFT marketplace (step S1140) is shown.

In FIG. 5, a flow of a process of a case where digital art offered to the NFT marketplace 10 is resold is shown.

As shown in FIG. 4, the original copyright holder terminal 50 performs an offer procedure by requesting the server device 20 to issue an NFT corresponding to digital content created by the original author (step S100). The original copyright holder terminal 50, for example, requests the issuance of an NFT corresponding to the digital content by transmitting an original copyright holder ID for identifying the original copyright holder, content information for the digital content to be offered, and the like to the server device 20.

The server device 20 executes information processing according to the NFT issuance request (step 101). The server device 20 assigns a content ID to the offered digital content and records an original copyright holder, a registration number, content information, an offeror, an offer date and time, and the like in association with each other.

The server device 20 generates the first information and the second information from the content information of the digital content for which an NFT issuance request has been received. The server device 20 issues an NFT associated with the content information and records information about the original author as the holder of the issued NFT in the first blockchain 30 (not shown in FIG. 4). The first blockchain 30 corresponds to a blockchain in a conventional trading system. If an NFT associated with the content information is issued and its holder is recorded on the blockchain, the offer for the NFT marketplace 10 is completed and the digital content is circulated as a trading target.

In addition, the server device 20 may record the digital content ID of the offered digital content and information such as the original copyright holder associated with the content ID in the first blockchain 30, in association with the NFT for the digital content.

Moreover, the server device 20 makes a registration request for requesting the second blockchain 40 to register the second information (step S102). For example, the NFT marketplace 10 issues an NFT associated with the second information and requests the second blockchain 40 to record information about the original author as the holder of the issued NFT on the second blockchain 40.

In response to the registration request provided in the notification from the server device 20, the second blockchain 40 records information about the original author as the holder of the NFT included in the registration request (step S103). If the recording of the NFT holder is completed, the second blockchain 40 transmits a registration completion notification indicating that the registration of the second information has been completed to the server device 20 (step S104).

In case that the registration completion notification indicating that the registration of the second information has been completed is received from the second blockchain 40, the server device 20 transmits the registration completion notification indicating that the offer registration has been completed to the original copyright holder terminal 50 (step S105).

On the other hand, the first purchaser terminal 70 performs a purchase procedure by transmitting a purchase request for the NFT associated with the NFT art to the server device 20 (step S106). The server device 20 executes information processing according to the NFT purchase request from Purchaser 1 (step S107). The server device 20 records a purchaser, a purchase number, or the like in association with the content ID of the purchased digital content.

The server device 20 sells the NFT that is a target of the NFT purchase request (the NFT associated with the first information) to Purchaser 1, and records information about Purchaser 1 who has made the NFT purchase request on the first blockchain 30 as information about the holder of the sold NFT. The server device 20 may also record the purchase number and the like on the first blockchain 30.

The server device 20 transmits a registration request for prompting the purchaser to register the viewing device to the first purchaser terminal 70. In case that a response to the registration request has been received from the first purchaser terminal 70, the server device 20 registers the viewing device by storing the viewing device's identification information included in the response as the circulation management information 270 in the storage 27. If the viewing device is registered, the server device 20 transmits first information corresponding to the NFT purchased by Purchaser 1 to the first purchaser terminal 70 (step S108). Moreover, the server device 20 transmits a display program to the first purchaser terminal 70.

The first purchaser terminal 70 performs a process for displaying (reproducing) the digital content on the viewing device (the first purchaser display 71) (step S109). In accordance with an operation from Purchaser 1, the first purchaser terminal 70 installs the display program on the first purchaser display 71 and stores the first information in the first purchaser display 71.

The first purchaser display 71 displays (reproduces) the digital content (step S110). In case that the display program is activated in accordance with an operation from Purchaser 1 and an operation for displaying digital content is performed, the first purchaser display 71 provides a request notification for requesting the transmission of the second information by transmitting its own (first purchase display 71) device identification information to the server device 20 (step S111). The server device 20 receives the request notification provided from the first purchaser display 71.

The server device 20 performs a process for transmitting the second information (step S112). Based on the device identification information included in the request notification received from the first purchaser display 71, the server device 20 determines whether or not the device (terminal device) having provided the request notification is a device registered as the viewing device. In case that the device having provided the request notification is a device registered as the viewing device, the server device 20 transmits the second information to the device having provided the request notification, i.e., the viewing device, the first purchaser display 71 in the drawing (step S113). The first purchaser display 71 displays the digital content using the first information and the second information. Thereby, the authentic digital content is reproduced on the first purchaser display 71.

Here, a process of a case where copied art is offered will be described as shown in Step S1140.

It is assumed that the first purchaser terminal 70 copies digital content purchased from the NFT marketplace 10 and performs a procedure for offering the copied art (step S114).

Because Purchaser 1 has no way of knowing that the first information within the content information of the digital content is circulating in the NFT marketplace 10, or that the second information is acquired by the viewing device in case that the digital content is displayed, Purchaser 1 recognizes that the first information circulating in the NFT marketplace 10 is the content information of the digital content itself. Therefore, in step S114, the first purchaser terminal 70 copies the first information as content information of the digital content and performs a procedure for offering the copied art.

The server device 20 attempts to generate first information and second information from the content information (the first information) corresponding to the NFT issuance request in step S114. Here, for ease of description, the first information serving as content information corresponding to the NFT issuance request in step S114 is referred to as “existing first information.” Moreover, the first information generated from the existing first information is referred to as “new first information.” The second information generated from the existing first information is referred to as “new second information.”

Here, it is assumed that the existing first information includes incomplete information. In this case, the server device 20 can determine whether or not the offered digital content is copied art based on whether or not the content information (existing first information) of the offered digital content is incomplete information. For example, the generator 22 determines whether the content information includes incomplete information before the first information and the second information are generated from the content information. In case that the content information includes incomplete information, the generator 22 determines that the content is a copy. In this case, it is determined that the offered digital content is copied art and a countermeasure such as the rejection of the offer for the NFT marketplace 10 is performed. On the other hand, in case that the content information does not include incomplete information, the generator 22 determines that the content is authentic. In this case, the generator 22 generates the first information and the second information from the content information.

However, in case that there is no function of checking whether or not the offered digital art is a copy at the time of offering, as in the conventional NFT marketplaces, the offer of existing first information (copied art) as a copy of authentic digital content is received and there is a possibility that the copied art (new first information thereof) may end up in circulation. The trading system 1 of the present embodiment makes it easy to detect copied art, even in case that the copied art is offered to the market using such conventional reception functions.

In case that the copied art (or new first information thereof) is circulated within the market, new first information and new second information are generated from the existing first information (copied art), the copied art and an NFT corresponding to its second information are issued, and information about its holder is recorded on the blockchain. Specifically, information about the holder of the NFT associated with the copied art is stored in the first blockchain 30, and information about the holder of the NFT associated with the new second information is stored in the second blockchain 40. The server device 20 transmits a registration completion notification to the first purchaser terminal 70 (step S115). The second purchaser terminal 80 performs the purchase procedure by transmitting a purchase request for the NFT associated with the copied art (or new first information thereof) to the server device 20 (step S116). Here, the server device 20 executes processing similar to that of steps S107 and S108, and transmits the new first information and a display program to the second purchaser terminal 80 as a process corresponding to step S108 (step S117). The second purchaser terminal 80 executes the process shown in steps S109 to S110.

Specifically, the second purchaser terminal 80 installs a display program on the viewing device (second purchaser display 81) registered in case that Purchaser 2 has purchased the NFT, and stores new first information in the second purchaser display 81. The second purchaser display 81 transmits a request notification for requesting the transmission of new second information to the server device 20 via the display program and receives new second information from the server device 20 in response to the request notification.

Here, the display program determines whether or not incomplete information is included in the content information based on the new first information and new second information (i.e., the existing first information). In case that the incomplete information is included, the second purchaser display 81 provides a notification to the server device 20 via the display program (step S118). This notification is a notification indicating that the digital content purchased by purchaser 2 is copied art. In case that the notification is received, the server device 20 identifies an offeror (in this case, Purchaser 1) who has offered target digital content (digital content purchased by Purchaser 2) and performs a countermeasure against the offeror (Purchaser 1), such as suspending the offeror's (Purchaser 1's) use within the market (step S119).

According to this configuration, the detection of copied art is facilitated even in case that the copied art is offered.

The processing shown in steps S200 to S213 of FIG. 5 is similar to that shown in steps S100 to S113 of FIG. 4, and therefore description thereof will be omitted.

The first purchaser terminal 70 performs a procedure for reselling the digital art purchased from the NFT marketplace 10 (step S214).

As in step S114, because Purchaser 1 has no way of knowing that the first information within the content information of the digital content is circulating in the NFT marketplace 10, or that the second information is acquired by the viewing device in case that the digital content is displayed, Purchaser 1 recognizes that the first information circulating in the NFT marketplace 10 is the content information of the digital content itself. Therefore, in step S214, the first purchaser terminal 70 performs a resale procedure for reselling the first information as content information for authentic digital content.

If the resale procedure is received, the server device 20 identifies the viewing device by reading the identification information of the viewing device registered in case that Purchaser 1 purchases digital content that is a resale target with reference to the circulation management information 270 for the digital content.

The server device 20 updates the holder of the NFT associated with the first information that is the resale target, and records information obtained by changing the holder from Purchaser 1 to a market administrator on the first blockchain 30.

The server device 20 transmits a return request for requesting the return of the second information to the viewing device (the first purchaser display 71 in the drawing) (step S215). This return request includes, for example, content for instructing the second blockchain 40 to return the second information. In response to the return request, the first purchaser display 71 transmits the second information to the second blockchain 40 via the display program (step S216). The second blockchain 40 updates the holder of the NFT associated with the second information and records information about a change of the holder from Purchaser 1 to the market administrator on the second blockchain 40. The second blockchain 40 transmits a registration completion notification indicating that registration of the second information has been completed to the first purchaser terminal 70 (step S 217).

In case that the registration completion notification is received from the second blockchain 40, the server device 20 transmits a registration completion notification indicating that the resale procedure has been completed to the first purchaser terminal 70 (step S218).

The second purchaser terminal 80 performs the purchase procedure by transmitting a purchase request for the NFT of the digital content offered for resale to the server device 20 (step S219). The subsequent processing shown in steps S220 to S226 is similar to the processing shown in steps S207 to S213, and therefore description thereof will be omitted.

As described above, the server device 20 of the embodiment includes the generator 22, the first respondent 25, and the second respondent 26. The generator 22 generates first information that is free of color information of digital content (an example of content) that is a trading target and second information corresponding to the color information, based on the content. The first respondent 25 transmits the first information and a registration request for requesting registration of a viewing device (a viewing terminal device) for viewing the content to a terminal device of a purchaser who has performed a content purchase procedure. The first respondent 25 stores identification information of the viewing device provided by a notification in response to the registration request in the storage 27. The second respondent 26 determines whether or not identification information of a terminal device included in a transmission request for requesting transmission of the second information matches the identification information of the viewing device stored in the storage 27 in case that the transmission request has been received. The second respondent 26 transmits the second information to the viewing device in case that it is determined that the identification information matches.

Thereby, the server device 20 of the embodiment is configured to divide the content information into two pieces of information, i.e., the first information and the second information, separately manages the first and second information, and display. authentic content based on the first information and the second information only on the viewing device of the purchaser who has purchased the first information. Because the purchaser has purchased the first information, a copy made from the first information is offered in case that the copy is intended to be offered. Because the first information is obtained by deleting partial information from the content information, it is difficult to imitate the authentic product. Accordingly, it is possible to make the copying of NFT art difficult. Moreover, because the second information is transmitted to the terminal device providing the request notification only in case that the terminal device providing the request notification is the viewing device (registered in the storage 27), the server device 20 of the embodiment can notify only the pre-registered viewing device of the second information and can deal with fraud such as an unregistered terminal device impersonating the viewing device and requesting the second information.

Moreover, the server device 20 of the embodiment further includes the first manager 23. The first manager 23 offers the content to a market in which the holder of the non-fungible token associated with the content is managed using the blockchain. Thereby, it is possible to manage a trading history of content offered to the market so that the trading history is not falsified.

Moreover, the server device 20 of the embodiment further includes the first manager 23. The first manager 23 may also be configured to offer content consisting only of first information to a market in which the holder of the non-fungible token is managed using the blockchain. Thereby, it is possible to designate the first information of content offered to the market as a trading target and manage the trading history of the first information so that the trading history is not falsified.

Moreover, in the server device 20 of the embodiment, the first respondent stores the viewing device's identification information in the offer management information 270 (information in which the first information and the second information are associated). Thereby, the server device 20 of the embodiment can store the first information and the second information of the content and the information about the viewing device in association.

Moreover, the server device 20 of the embodiment includes the second manager 24. The second manager 24 manages second information by managing a non-fungible token (NFT) associated with the second information using the second blockchain 40. Thereby, the server device 20 of the embodiment can manage a history of attribute information (e.g., the holder) of the second information in association with the NFT managed by the blockchain. Therefore, it is possible to manage the history of attribute information (e.g., the holder) of the second information so that it is difficult to falsify the history.

Moreover, in the server device 20 of the embodiment, the first respondent 25 transmits a display program for displaying content on the viewing device based on the first information and the second information. In response to an operation for displaying content on the viewing device, the display program executes a request notification for requesting the second information by causing the viewing device to transmit the viewing device's identification information. The display program displays the content on the viewing device using the second information in a notification provided to the viewing device in response to the request notification. Thereby, the server device 20 of the embodiment can display authentic content only on the viewing device.

Moreover, in the server device 20 of the embodiment, the first information includes incomplete information indicated to be information in which partial information has been excluded from the content. The display program determines whether or not the content to be displayed on the viewing device is a copy in accordance with whether or not the content information based on the first information and the second information includes incomplete information. In the server device 20 of the embodiment, in case that copied art obtained by copying digital content purchased by Purchaser 1 is offered, a copy of the first information is offered. The first information includes the incomplete information. By determining whether or not the content information includes incomplete information in case that displaying the content on the viewing device, the display program makes it easy to determine whether or not the content purchased by Purchaser 2 is a copy.

Moreover, in the server device 20 of the embodiment, the first information includes incomplete information indicated to be information in which partial information has been excluded from the content. The generator 22 determines whether or not the content is a copy in accordance with whether or not the content information includes incomplete information. Thereby, in the server device 20 of the embodiment, the first information includes incomplete information, making it easy to determine whether or not the content is a copy in accordance with whether or not the content information includes incomplete information.

Here, a basic configuration of the server device of the trading system will be described using FIG. 7. FIG. 7 is a block diagram showing a basic configuration of the server device 2 in the embodiment. The server device 2 includes a generator 3, a first manager 4, a second manager 5, a first respondent 6, and a second respondent 7. The generator 3 generates first information obtained by excluding color information of content that is a trading target from content information of the content, and second information, which is the color information of the content information. The first manager 4 circulates a non-fungible token associated with the first information in a market in which a holder of the non-fungible token is managed using a blockchain. The second manager 5 manages the second information in association with the first information. The first respondent 6 transmits a registration request for requesting registration of the viewing device on which the purchaser will view the purchased content to a terminal device of the purchaser who has purchased the non-fungible token associated with the first information. The first respondent 6 stores the identification information of the viewing device provided in a notification in response to the registration request in the storage. The second respondent 7 transmits the second information corresponding to the content purchased by the purchaser to the viewing device based on the viewing device's identification information stored in the storage.

Moreover, a program for implementing the functions of the trading system 1, the NFT marketplace 10, and the server device 20 in FIG. 1 is recorded on a computer-readable recording medium, and the program recorded on the recording medium may be read into a computer system and executed to perform position detection. In addition, the “computer system” used here is assumed to include an operating system (OS) or hardware such as peripheral devices.

Moreover, the “computer system” is assumed to include a homepage provision environment (or display environment) if a World Wide Web (WWW) system is used.

Moreover, the “computer-readable recording medium” refers to a flexible disk, a magneto-optical disc, a read-only memory (ROM), a portable medium such as a compact disc-ROM (CD-ROM), or a storage device such as a hard disk embedded in the computer system. Furthermore, the “computer-readable recording medium” is assumed to include a medium that holds a program for a certain period of time, such as a volatile memory inside a computer system serving as a server or a client. Moreover, the above-described program may be a program for implementing some of the above-described functions. Further, the above-described function may be implemented in combination with a program already recorded on the computer system. Moreover, the above-described program may be stored in a predetermined server and the program may be distributed (downloaded or the like) via a communication circuit in response to a request from another device.

Although embodiments of the present invention have been described in detail above with reference to the drawings, specific configurations are not limited to the embodiments and other designs and the like may also be included without departing from the scope and spirit of the present invention.

For example, an example in which management using the blockchain is implemented in an NFT marketplace has been described in the above-described embodiment, but the present invention is not limited thereto. The history of buying and selling in the marketplace may be managed using not only a blockchain but also technology that ensures the accuracy of trading while decentralizing data management, such as a directed acyclic graph (DAG).

### EXPLANATION OF REFERENCES

1 Trading system
10 NFT marketplace
2, 20, 200 Server device
21 Acquisition unit
3, 22 Generator
4, 23 First manager
5, 24 Second manager
6, 25 First respondent
7, 26 Second respondent
27 Storage
270 Circulation management information
30 First blockchain
40 Second blockchain
50 Original copyright holder terminal
70 First purchaser terminal
71 First purchaser display
80 Second purchaser terminal
81 Second purchaser display

What is claimed is:

1. A server device comprising:
a generator configured to generate, based on a content as a trading target, a first information that is free of color information of the content and a second information corresponding to the color information;
a first respondent configured to transmit the first information and a registration request into a terminal device of a purchaser who has performed a content purchase procedure, where the registration request is a request for registration of a viewing terminal device for viewing the content, the first respondent configured to store, in a storage, an identification information of the viewing terminal device, where the identification information having been notified in response to the registration request; and
a second respondent configured to determine, in case that a transmission request for transmitting the second information has been received, whether or not an identification information of a terminal device included in the transmission request matches the identification information of the viewing terminal device stored in the storage, the second respondent configured to transmit the second information to the viewing terminal device in case that the second respondent determined that the identification information of the terminal device included in the transmission request matches the identification information of the viewing terminal device.

2. The server device according to claim 1, further comprising:
a first manager configured to offer a content to a market, wherein the market manages a holder of a non-fungible token, and the non-fungible token is associated with the content using a blockchain.

3. The server device according to claim 1, further comprising:
a first manager configured to offer a content including only the first information to a market, wherein the market manages a holder of a non-fungible token, and the non-fungible token is associated with the content using a blockchain.

4. The server device according to claim 1, wherein the first respondent stores the identification information of the viewing terminal device in an offer management information of associating the first information and the second information with each other.

5. The server device according to claim 1, further comprising:
a second manager configured to manage the second information by managing a non-fungible token that is associated with the second information using a blockchain.

6. The server device according to claim 1, wherein
the first respondent is configured to transmit a display program for displaying the content on the viewing terminal device based on the first information and the second information, and
the display program is, when executed, to perform a request notification for requesting the second information by transmitting the identification information of the viewing terminal device from the viewing terminal device in accordance with an operation for displaying the content and to cause the viewing terminal device to display the content using the second information provided by the notification to the viewing terminal device in accordance with the request notification.

7. The server device according to claim 6,
wherein the first information includes an incomplete information indicating that a partial information is excluded from the content, and
wherein the display program is, when executed, to determine whether or not the content to be displayed on the viewing terminal device is a copy in accordance with whether or not the incomplete information is included in the content based on the first information and the second information.

8. The server device according to claim 1,
wherein the first information includes incomplete information indicated to be information in which partial information is excluded from the content, and
wherein the generator is configured to determine whether or not the content is a copy, based on whether or not the content includes the incomplete information.

9. A trading system comprising:
a server device; and
a viewing terminal device,
wherein the server device comprises:
a generator configured to generate, based on a content as a trading target, a first information that is free of color information of the content and a second information corresponding to the color information;
a first respondent configured to transmit the first information and a registration request into a terminal device of a purchaser who has performed a content purchase procedure, where the registration request is a request for registration of a viewing terminal device for viewing the content, the first respondent configured to store, in a storage, an identification information of the viewing terminal device, where the identification information having been notified in response to the registration request; and
a second respondent configured to determine, in case that a transmission request for transmitting the second information has been received, whether or not an identification information of a terminal device included in the transmission request matches the identification information of the viewing terminal device stored in the storage, the second respondent configured to transmit the second information to the viewing terminal device in case that the second respondent determined that the identification information of the terminal device included in the transmission request matches the identification information of the viewing terminal device.

10. A trading method performed by a server device that is a computer, the trading method comprising:
generating, by an acquisitor of the server device, based on a content as a trading target, a first information that is free of color information of the content and a second information corresponding to the color information;
transmitting, by a first respondent of the server device, the first information and a registration request into a terminal device of a purchaser who has performed a content purchase procedure, where the registration request is a request for registration of a viewing terminal device for viewing the content, the first respondent configured to store, in a storage, an identification information of the viewing terminal device, where the identification information having been notified in response to the registration request; and
determining, by a second respondent of the server device,, in case that a transmission request for transmitting the second information has been received, whether or not an identification information of a terminal device included in the transmission request matches the identification information of the viewing terminal device stored in the storage, the second respondent configured to transmit the second information to the viewing terminal device in case that the second respondent determined that the identification information of the terminal device included in the transmission request matches the identification information of the viewing terminal device.
